(19) United States
(12) Patent Application Publication
(10) Pub. No.: US 2015/0217439 A1
(43) Pub. Date: Aug. 6, 2015

(54) BLADE-REPLACEABLE SAW

(71) Applicant: Shoji Miyawaki, Hyogo (JP)

(72) Inventor: Shoji Miyawaki, Hyogo (JP)

(73) Assignee: UM: KOGYO INC., Ono-shi, Hyogo (JP)

(21) Appl. No.: 14/422,761

(22) PCT Filed: Aug. 31, 2012
(86) PCT No.: PCT/JP2012/072156

§ 371 Date: Feb. 20, 2015

(51) Int. Cl. B25G 3/02; B27B 21/00

(52) U.S. Cl. CPC B25G 3/02; B27B 21/00

(57) ABSTRACT

A blade-replaceable saw is provided which enables blade replacement work without the need of an additional connecting fitting or the like, facilitates extraction and insertion of saw blades with respect to the grip during that work, and also prevents looseness between the saw blade and the grip even during the use of the saw. The blade-replaceable saw has a saw blade (10) and a grip (20), the saw blade (10) having on its base side a flat insertion handle section (12) configured to be inserted into the grip (20), the grip (20) having a flat insertion slot (22) for receiving the insertion handle section (12) of the saw blade (10), the saw enabling replacement of the saw blade (10). A projection (24) is formed on an inner wall surface (22a) of the flat insertion slot (22) of the grip (20), for reducing the contact area with, and also reducing the contact gap with, the flat insertion handle section (12) of the saw blade (10).

### TECHNICAL FIELD

The present invention relates to a blade-replaceable saw, and more particularly to a saw having its saw blade detachable from a grip for replacement.

### BACKGROUND ART

Blade-replaceable saws are convenient in that, when a saw blade becomes dull, for example, the saw blade alone can be detached from the grip and replaced with a new saw blade.

Japanese Utility Model Application Publication No. 5-5402 (Patent Document 1) discloses a blade-replaceable saw in which, for replacement of a saw blade (3) with respect to a handle (2) or a grip, a metal fitting called a back metal (4) is used so that the blade replacement is performed through the back metal (4). A variety of such blade-replaceable saws that allow the saw blade to be replaced with respect to the grip by the use of the metal fitting called the back metal have been disclosed. These saws, however, need the additional metal fitting called the back metal.

Japanese Patent Application Laid-Open No. 8-155903 (Patent Document 2) discloses a blade-replaceable hand saw in which a saw plate (20) is directly inserted into a mounting groove (11) of a grip (10), and extracted from the groove for blade replacement. In this invention, the saw plate (20) is inserted and extracted along a long opening of the mounting groove (11), ensuring easy insertion and extraction of the saw plate (20) along the long opening of the mounting groove (11). If the groove (11) is formed as a hole, however, the insertion and extraction of the saw plate (20) will not necessarily be easy.

Japanese Utility Model Registration No. 3143035 (Patent Document 3) discloses a blade-replaceable saw in which a core (31) of a saw body (2) is directly inserted into an insertion space (10) in a saw handle (1) and screw-fastened.

### PRIOR ART DOCUMENTS

### Patent Documents

Patent Document 1: Japanese Utility Model Application Publication No. 5-5402
Patent Document 2: Japanese Patent Application Laid-Open No. 8-155903
Patent Document 3: Japanese Utility Model Registration No. 3143035

### DISCLOSURE OF THE INVENTION

### Problems to be Solved by the Invention

The blade-replaceable saw disclosed in Patent Document 3 above is beneficial in that it does not require a connecting fitting like the back metal used in the invention of Patent Document 1. Further, it does not require a groove like the one provided in Patent Document 2, and thus, a groove opening is not exposed to the outside.

With the blade-replaceable saw in Patent Document 3, however, the core (31) of the saw body (2) is directly inserted into the insertion space (10) which is a flat hole bored in the saw handle (1). Thus, the insertion and extraction of the core (31) to and from the insertion space (10) are not necessarily easy, except the case where the core (31) is short in length. Particularly in the case where the saw handle (1) is made of rubber or elastomer, once the core (31) is inserted, it will become in close contact with the inner wall surfaces of the insertion space (10), hindering smooth extraction of the core (31).

In order to ensure smooth extraction of the core (31), the insertion space (10) needs to be increased in size. Increasing the size of the insertion space (10) relative to that of the core (31), however, would likely cause looseness. With such looseness, during the use of the saw for cutting, uncomfortable vibrations will occur, and the coupling means such as bolt and nut will be loosened, causing degradation in working efficiency due to fatigue and also degradation in cutting performance, as well as deterioration in usability of the saw.

On the other hand, if the core (31) is made shorter and narrower, the coupling strength with the saw handle (1) would likely become weak. Further, when they are assembled, looseness would likely occur.

In view of the foregoing, an object of the present invention is to solve the problems of the conventional blade-replaceable saws as described above by providing a blade-replaceable saw which enables blade replacement work without the need of an additional connecting fitting or the like, facilitates extraction and insertion of saw blades with respect to the grip during that work, and also prevents looseness between the saw blade and the grip even during the use of the saw.

### Means for Solving the Problems

A blade-replaceable saw according to the present invention has a first feature that it has a saw blade and a grip, the saw blade having on a base side thereof a flat insertion handle section configured to be inserted into the grip, the grip having a flat insertion slot for receiving the insertion handle section of the saw blade, the saw enabling replacement of the saw blade, wherein

a projection is formed on an inner wall surface of the flat insertion slot of the grip, for reducing a contact area with, and also reducing a contact gap with, the flat insertion handle section of the saw blade.

Further, the blade-replaceable saw according to the present invention has, in addition to the above-described first feature, a second feature that the projection on the inner wall surface of the flat insertion slot of the grip is formed on each of the inner wall surfaces that face front and rear surfaces, respectively, of the flat insertion handle section of the saw blade.

Further, the blade-replaceable saw according to the present invention has, in addition to the above-described second feature, a third feature that the projections formed on the inner wall surfaces of the insertion slot of the grip to face the front and rear surfaces of the insertion handle section of the saw blade include elongated rib-shaped projections arranged along a longitudinal direction of the insertion slot.

Further, the blade-replaceable saw according to the present invention has, in addition to the above-described second feature, a fourth feature that the projections formed on the inner wall surfaces of the insertion slot of the grip to face the front and rear surfaces of the insertion handle section of the saw blade include a large number of small projections.

Further, the blade-replaceable saw according to the present invention has, in addition to the above-described third feature, a fifth feature that the projections formed on the inner wall surfaces of the insertion slot of the grip to face the front and rear surfaces of the insertion handle section of the saw blade include the rib-shaped projections and a large number of small projections.

Further, the blade-replaceable saw according to the present invention has, in addition to the above-described fourth or fifth feature, a sixth feature that, instead of forming the small projections, surface roughening is carried out by one or more of electro-discharge machining, corrosion embossing, sandblasting, and other surface roughening processing.

Further, the blade-replaceable saw according to the present invention has, in addition to any of the above-described second through sixth features, a seventh feature that the projections on the inner wall surfaces of the flat insertion slot of the grip also include projections formed on the inner wall surfaces that face surfaces in a thickness direction of the flat insertion handle section of the saw blade.

Further, the blade-replaceable saw according to the present invention has, in addition to any of the above-described second through seventh features, an eighth feature that the saw blade is made of metal and the grip is made of rubber, resin, or other material having elasticity.

### Effects of the Invention

According to the blade-replaceable saw recited in claim 1, for replacement of the saw blade, the saw blade is extracted from the grip and a new saw blade is inserted into the grip.

At the time of extracting the saw blade from the grip, the flat insertion handle section of the saw blade would likely be in close surface contact with the inner wall surfaces of the flat insertion slot of the grip, hindering smooth extraction of the saw blade. This problem is noticeable especially when the grip is made of rubber or other material having a large coefficient of friction.

Therefore, in order to ensure smooth extraction of the saw blade, it was considered to increase the clearance (gap) between the insertion slot of the grip and the insertion handle section of the saw blade, and such an approach was adopted conventionally. When the gap between the insertion slot of the grip and the insertion handle section of the saw blade was increased, however, such a large gap would cause looseness between the saw blade and the grip.

According to the blade-replaceable saw recited in claim 1, the projection is formed on the flat inner wall surface of the grip to reduce the contact area with, and also reduce the contact gap with, the flat insertion handle section of the saw blade. This projection can reduce the contact area between the insertion handle section of the saw blade and the inner wall surface of the insertion slot of the grip, so it is possible to smoothly extract the saw blade with less resistance. Naturally, it is also possible to smoothly insert it. Additionally, the projection can reduce the contact gap between the insertion handle section of the saw blade and the inner wall surface of the insertion slot of the grip, so it is possible to suppress looseness between the saw blade and the grip.

According to the blade-replaceable saw recited in claim 2, in addition to the functions and effects obtained by the configuration recited in claim 1, the projection on the inner wall surface of the flat insertion slot of the grip is formed on each of the inner wall surfaces that face the front and rear surfaces, respectively, of the flat insertion handle section of the saw blade.

This configuration can reduce the contact area between the large-area front and rear surfaces of the insertion handle section and the opposing inner wall surfaces of the insertion slot of the grip. The contact resistance at the time of extracting the saw blade is sufficiently reduced, ensuring smooth extraction as well as insertion. The above configuration can also reduce the contact gap between the large-area front and rear surfaces of the insertion handle section and the opposing inner wall surfaces of the insertion slot, making it possible to sufficiently suppress the looseness between the saw blade and the grip.

According to the blade-replaceable saw recited in claim 3, in addition to the functions and effects obtained by the configuration recited in claim 2, the projections formed on the inner wall surfaces of the insertion slot of the grip to face the front and rear surfaces of the insertion handle section of the saw blade include the elongated rib-shaped projections arranged along the longitudinal direction of the insertion slot.

With this configuration, the large-area front and rear surfaces of the insertion handle section come into contact with only the elongated rib-shaped projections formed along the longitudinal direction on the inner wall surfaces of the insertion slot of the grip. This enables very smooth extraction and insertion of the saw blade. As a matter of course, the elongated rib-shaped projections arranged along the longitudinal direction can reliably reduce the contact gap between the insertion handle section and the inner wall surfaces of the insertion slot along the longitudinal direction, so it is possible to sufficiently suppress the looseness between the saw blade and the grip.

According to the blade-replaceable saw recited in claim 4, in addition to the functions and effects obtained by the configuration recited in claim 2, the projections formed on the inner wall surfaces of the insertion slot of the grip to face the front and rear surfaces of the insertion handle section of the saw blade include a large number of small projections.

The presence of the large number of small projections can reduce the contact area between the front and rear surfaces of the insertion handle section and the inner wall surfaces of the insertion slot. The contact resistance therebetween is sufficiently reduced, ensuring smooth extraction and insertion. Moreover, the small projections formed can reduce the gap between the front and rear surfaces of the insertion handle section and the inner wall surfaces of the insertion slot, and can suppress the looseness between the saw blade and the grip correspondingly.

According to the blade-replaceable saw recited in claim 5, in addition to the functions and effects obtained by the configuration recited in claim 3, the projections formed on the inner wall surfaces of the insertion slot of the grip to face the front and rear surfaces of the insertion handle section of the saw blade include the rib-shaped projections and a large number of small projections.

With this configuration, in addition to the effect of enabling smooth extraction and insertion of the saw blade and the effect of suppressing the looseness by the elongated rib-shaped projections formed along the longitudinal direction of the insertion slot, the large number of small projections can further enhance the effect of enabling smooth extraction and insertion of the saw blade.

According to the blade-replaceable saw recited in claim 6, in addition to the functions and effects obtained by the configuration recited in claim 4 or 5, instead of forming the small projections, surface roughening is carried out by one or more of electro-discharge machining, corrosion embossing, sandblasting, and other surface roughening processing.

Such roughening of the inner wall surfaces of the insertion slot of the grip that face the front and rear surfaces of the insertion handle section of the saw blade can effectively prevent the front and rear surfaces of the insertion handle section of the saw blade from coming into close contact with the inner wall surfaces of the insertion slot. The contact resistance can thus be reduced, ensuring smooth extraction and insertion of the saw blade. Further, as the roughened surfaces alleviate the close contact of the saw blade in the insertion slot, the gap between the saw blade and the inner wall surfaces of the insertion slot can be kept small, and the looseness of the saw blade can also be reduced.

According to the blade-replaceable saw recited in claim 7, in addition to the functions and effects obtained by the configuration recited in any of claims 2 to 6, the projections on the inner wall surfaces of the flat insertion slot of the grip also include the projections formed on the inner wall surfaces that face the surfaces in the thickness direction of the flat insertion handle section.

This configuration can reduce the contact between the surfaces in the thickness direction of the insertion handle section of the saw blade and the inner wall surfaces of the insertion slot, enabling smoother extraction and insertion of the saw blade. Moreover, it can reduce the contact gap between the surfaces in the thickness direction of the saw blade and the opposing inner wall surfaces of the insertion slot of the grip, and therefore, the looseness of the saw blade can further be reduced correspondingly.

According to the blade-replaceable saw recited in claim 8, in addition to the functions and effects obtained by the configuration recited in any of claims 1 to 7, the saw blade is made of metal and the grip is made of rubber, resin, or other material having elasticity.

Therefore, even in the case of extracting or inserting the metal saw blade from or into the insertion slot of the grip made of rubber, resin, or other material with elasticity, the metal saw blade would not likely be in close contact with the inner wall surfaces of the insertion slot of the grip, ensuring smooth extraction and insertion thereof. It is also possible to reduce the gap between the saw blade and the insertion slot, and thus, to reduce the looseness.

### BRIEF DESCRIPTION OF THE DRAWINGS

FIG. 1 is a perspective view of a blade-replaceable saw according to an embodiment of the present invention.

FIG. 2 is a front view of the blade-replaceable saw according to the embodiment of the present invention.

FIG. 3 is a vertical cross-sectional view of a main part of the blade-replaceable saw according to the embodiment of the present invention.

FIG. 4 is a vertical cross-sectional view of the grip of the blade-replaceable saw according to the embodiment of the present invention.

FIG. 5 is a cross-sectional view taken in the direction A-A of the grip of the blade-replaceable saw according to the embodiment of the present invention.

FIG. 6 is a partial enlarged view of FIG. 5, with the saw blade being indicated by a broken line.

### MODES FOR CARRYING OUT THE INVENTION

A blade-replaceable saw according to an embodiment of the present invention will be described below with reference to the drawings for understanding of the present invention. The following description, however, is not intended to limit the invention set forth in the claims.

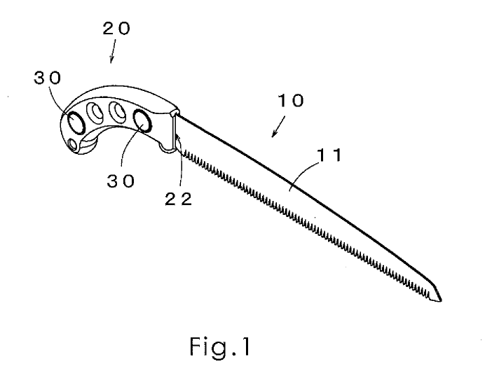

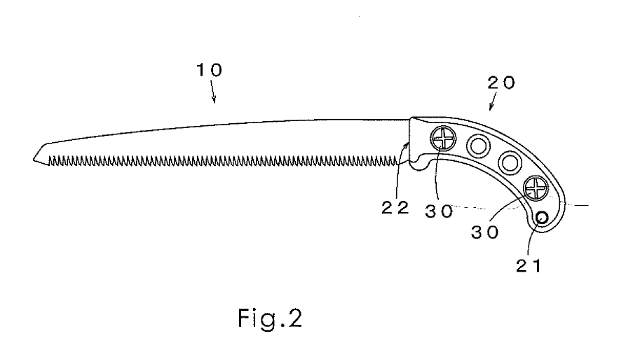

Referring first to FIGS. 1 and 2, the blade-replaceable saw of the present invention has a saw blade 10, a grip 20, and coupling means 30 for coupling them.

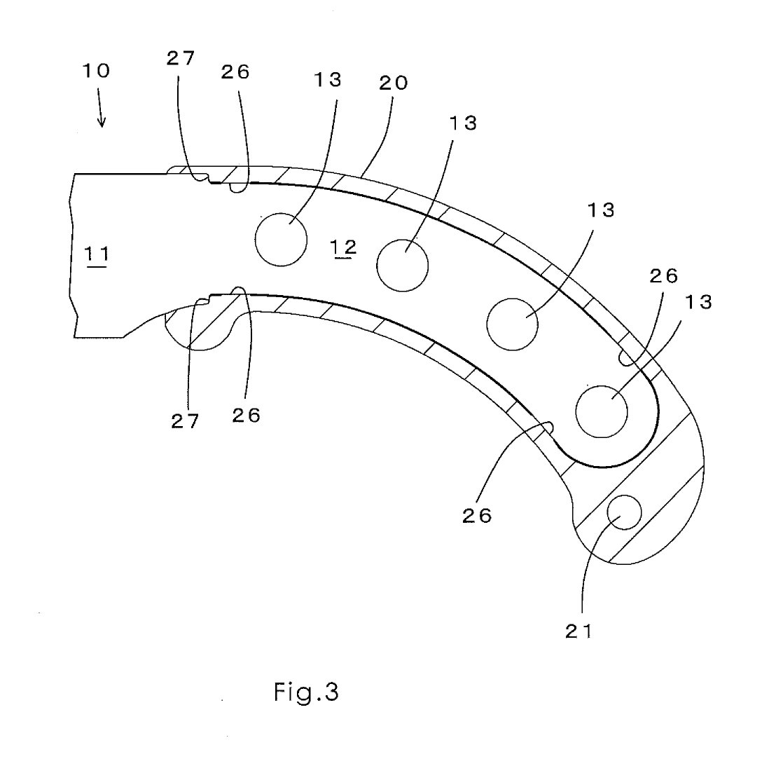

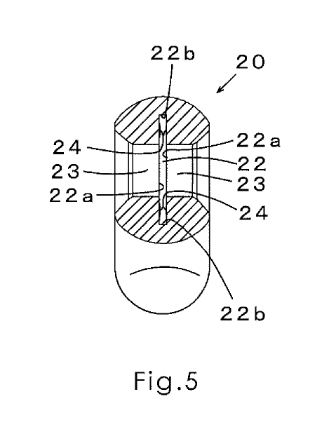

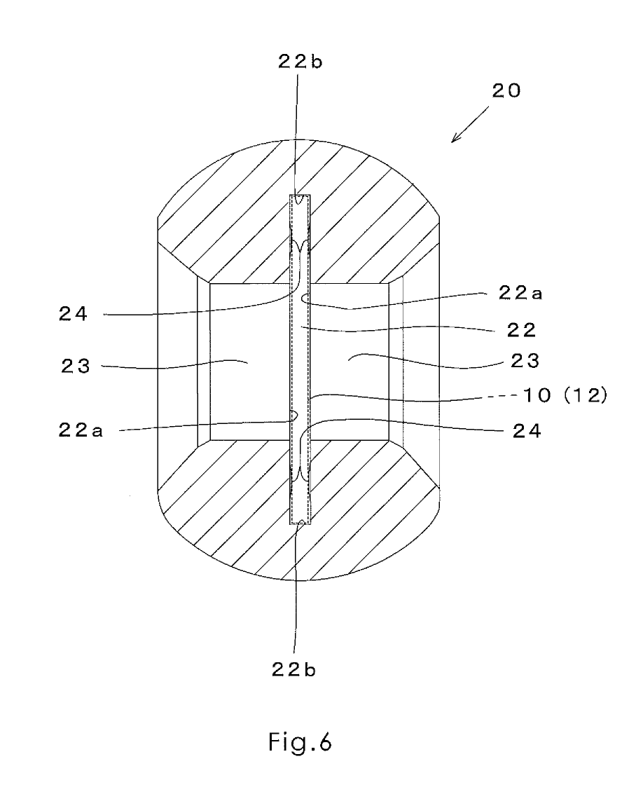

Referring also to FIGS. 3 to 6, the saw blade 10 has a saw blade body 11, which is toothed and in a flat, elongated shape with a thickness of 1.4 mm, a total length of about 400 mm, and a width of about 25 mm to about 40 mm, for example, and an insertion handle section 12, which is provided continuously on a base side thereof (see FIG. 3).

The insertion handle section 12 is a handle section which is configured to be inserted into the grip 20. This insertion handle section 12 is flat, strip-shaped, and curved in the longitudinal direction. The insertion handle section 12 has a thickness of about 1.5 mm, a total length of about 110 mm to about 120 mm, and a width of about 25 mm, for example.

The insertion handle section 12 is provided with through holes 13 along the longitudinal direction. The one shown in FIGS. 1 and 2 has four such through holes 13 along the longitudinal direction at the central portion of the insertion handle section 12. It is configured such that bolts and nuts, serving actually as the coupling means 30, are attached to two through holes 13, 13 at the respective ends among the four through holes 13 for coupling. In the present embodiment, the remaining two through holes 13, 13 at the center are actually left open; they are used to reduce the weight, or to add a design to the combination with the grip 20.

The saw blade 10 is made of stainless steel, although it may be made of other metal. It may also be made of ceramic.

On the other hand, the grip 20 has a thickness of about 22 mm, a total length of about 130 mm to about 140 mm, and a width of about 34 mm, for example, and is in a curved shape in the longitudinal direction corresponding to the curved shape of the insertion handle section 12.

The grip may be made of rubber, resin elastomer, or other elastic body. It may of course be made of another material.

The grip 20 has a flat insertion slot 22 formed at the center of its thickness, for receiving the insertion handle section 12 of the saw blade 10.

The grip 20 also has through holes 23 formed along the longitudinal direction. In the embodiment shown in FIGS. 1 and 2, four such through holes 23 are arranged along the longitudinal direction at the central portion of the grip 20. It is configured such that bolts and nuts, serving as the coupling means 30, are attached to two through holes 23, 23 at the respective ends among the four through holes 23, for coupling between the grip 20 and the saw blade 10. The remaining two through holes 23, 23 at the center are actually left open; they are for adding a design, or for reducing the weight, as described above. It is of course possible to attach additional coupling means 30 to those unused through holes 23, as required, for more secure coupling.

The insertion slot 22 formed at the center of thickness of the grip 20 has a length close to the total length in the longitudinal direction of the grip 20. More specifically, the insertion slot 22 extends over the total length of the grip 20 excluding the region near the distal end of the grip 20 where a strap hole 21 is provided.

The size in the longitudinal direction (hereinafter, referred to as “longitudinal size”) of this insertion slot 22 is preferably at least a half of the longitudinal size of the grip 20.

When the longitudinal size of the insertion slot 22 is thus made sufficiently long, instead of being limited to the proximity of the insertion mouth of the insertion slot 22, reliable and stable coupling with no looseness can be realized between the saw blade 10 and the grip 20, without requiring a special connecting fitting called a back metal, which was commonly found in conventional blade-replaceable saws.

Further, for the same reasons, the size in the shorter direction (hereinafter, referred to as “width size”) of the insertion slot 22 is set to a size close to the total width in the shorter direction of the grip 20. For example, when the width size of the grip 20 is 34 mm, the width size of the insertion slot 22 is set to be 27 mm.

The width size of the insertion slot 22 is preferably at least two thirds of the width size of the grip 20. When the width size of the insertion slot 22 of the grip 20 is made sufficiently large, the width of the insertion handle section 12 of the saw blade 10 can also be made sufficiently large, thereby ensuring stable coupling therebetween with a little looseness.

The configuration inside the insertion slot 22 will now be described with reference to FIGS. 3 to 6.

The insertion slot 22 has an inner wall surface made up of inner wall surfaces 22a, 22a which face the front and rear surfaces, respectively, of the flat insertion handle section 12 of the saw blade 10, and inner wall surfaces 22b, 22b which face the surfaces in the thickness direction of the flat insertion handle section 12.

On each of the inner wall surfaces 22a, 22a of the insertion slot 22 facing the front and rear surfaces of the insertion handle section 12, a pair of elongated rib-shaped projections 24 are provided along the longitudinal direction of the insertion slot 22.

Each rib-shaped projection 24 is in a curved shape corresponding to the curves of the grip 20 and the insertion handle section 12.

The paired rib-shaped projections 24, 24 are arranged spaced apart from each other on the inner wall surface 22a, on the respective sides in the shorter direction (width direction) of the insertion slot 22.

The rib of the rib-shaped projection 24 is in a trapezoidal shape in cross section. For example, the upper surface of the trapezoid has a width of about 1 mm with respect to the width of 34 mm of the grip 20 and the width of 27 mm of the inner wall surface 22a. The cross-sectional shape of the rib-shaped projection 24 is of course not particularly limited.

The first role of the rib-shaped projections 24 is to prevent the front and rear surfaces of the flat insertion handle section 12 of the saw blade 10 from being firmly and entirely brought into surface contact with the opposing inner wall surfaces 22a of the insertion slot 22 of the grip 20, and sufficiently reduce the contact area when they come into contact with each other.

With the rib-shaped projections 24 extending in the longitudinal direction, the contact between the insertion handle section 12 and the inner wall surface 22a over the entire region along the longitudinal direction can surely be prevented, and the contact area when they come into contact with each other along the longitudinal direction can be reduced sufficiently. The thus reduced contact area facilitates the insertion and extraction of the saw blade 10.

As a matter of course, as for the rib-shaped projections 24, when the insertion handle section 12 of the saw blade 10 and the grip 20 are fastened together by the coupling means 30, as will be described later, the regions around the rib-shaped projections 24 would likely come into contact with the surfaces of the insertion handle section 12. At this time, however, not all the regions around the rib-shaped projections 24 will attain the contact state; non-contact regions will surely remain. When the coupling means 30 are removed and the saw blade 10 is to be extracted from the grip 20, the close contact state between the insertion handle section 12 and the grip 20 will be released from those non-contact regions, and the release of the close contact state will rapidly advance, thereby facilitating the extraction of the saw blade 10.

The second role of the rib-shaped projections 24 is to reduce the gap, or in other words, the contact gap, between the front and rear surfaces of the flat insertion handle section 12 of the saw blade 10 and the opposing inner wall surfaces 22a of the insertion slot 22 of the grip 20, and thereby reduce looseness due to the gap between the insertion handle section 12 and the insertion slot 22.

With the rib-shaped projections 24 extending in the longitudinal direction, a large gap over the longitudinal direction between the insertion handle section 12 and the inner wall surface 22a can be eliminated, and the occurrence of looseness over the longitudinal direction can be sufficiently reduced.

The actual dimensional relation between the saw blade 10 and the insertion slot 22 is as follows: the insertion handle section 12 of the saw blade 10 is 1.4 mm in thickness, the insertion slot 22 is 1.8 mm in thickness, and the rib-shaped projection 24 is 0.15 mm in height. Accordingly, inside the insertion slot 22, the total gap between the insertion handle section 12 and the rib-shaped projections 24, 24 on its respective sides is 0.1 mm. Such a gap can significantly reduce the looseness of the insertion handle section 12 inside the insertion slot 22.

On the inner wall surfaces 22a of the insertion slot 22, a plurality of projections may be distributed instead of the rib-shaped projections 24. Alternatively, a large number of small projections 25 may be formed over the inner wall surfaces 22a.

In such cases, the plurality of projections or the large number of small projections 25 take the role of the rib-shaped projections 24, i.e. the first role of reducing the contact area between the insertion handle section 12 and the inner wall surfaces 22a of the insertion slot 22, and the second role of reducing the contact gap between the insertion handle section 12 and the inner wall surfaces 22a of the insertion slot 22.

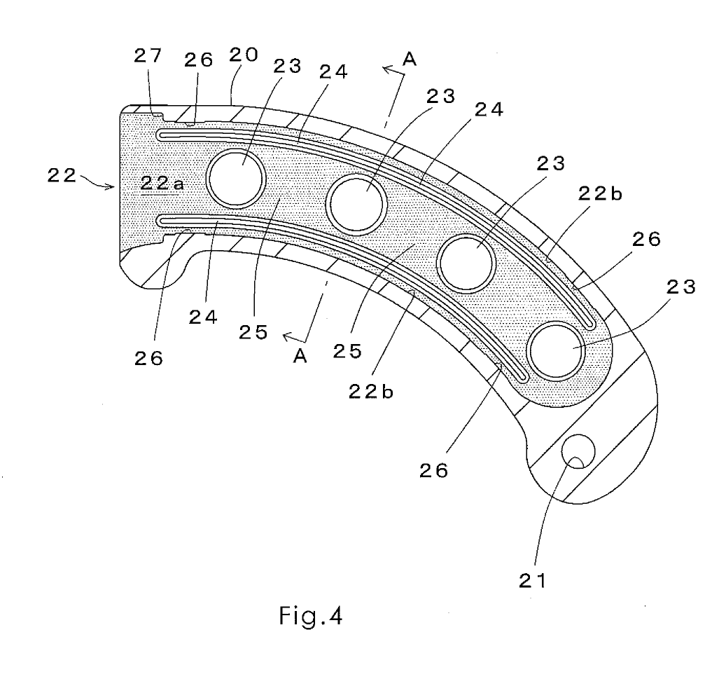

The large number of small projections 25 may be provided together with the rib-shaped projections 24, as shown in FIG. 4. In this case, the large number of small projections 25 may be distributed over the entire surfaces of the inner wall surfaces 22a, excluding the regions of the rib-shaped projections 24 and the through holes 23.

It is preferable that the small projections 25 provided together with the rib-shaped projections 24 are slightly lower in height than the rib-shaped projections 24. Such small projections 25, lower in height than the rib-shaped projections 24, prevent the insertion handle section 12 of the saw blade 10 from coming into close surface contact with the inner wall surfaces 22a of the insertion slot 22 in the regions other than the rib-shaped projections 24. This facilitates extraction and insertion of the saw blade 10.

Instead of forming the small projections 25, the surfaces may be roughened by performing one or more of electro-discharge machining, corrosion embossing, sandblasting, and other surface roughening processing. Roughening the surfaces means to provide fine irregularities over the surfaces of the inner wall surfaces 22a.

Such surface roughening can effectively prevent the front and rear surfaces of the insertion handle section 12 of the saw blade 10 from being brought into close contact with the inner wall surfaces 22a of the insertion slot 22 of the grip 20.

Of the inner wall surfaces of the insertion slot 22, the inner wall surfaces 22b facing the surfaces in the thickness direction of the flat insertion handle section 12 of the saw blade 10 are also provided with projections, which are referred to as “second projections 26”.

The second projections 26 are arranged as pairs at the positions near the entrance and near the deepest portion in the longitudinal direction of the insertion slot 22. The second projections 26 protrude slightly from the inner wall surfaces 22b, to effectively prevent the surfaces in the thickness direction around the insertion handle section 12 of the saw blade 10 from being entirely brought into surface contact with the inner wall surfaces 22b of the insertion slot 22. This enables smooth extraction and insertion of the saw blade 10. They can also reduce the contact gap between the surfaces in the thickness direction around the insertion handle section 12 of the saw blade 10 and the inner wall surfaces 22b of the insertion slot 22, and therefore, the looseness of the saw blade can be reduced correspondingly.

It should be noted that the inner wall surfaces 22b of the insertion slot 22 of the grip 20 facing the surfaces in the thickness direction of the flat insertion handle section 12 of the saw blade 10 are provided with a pair of insertion preventing steps 27, which are arranged immediately behind the mouth of the insertion slot 22. These insertion preventing steps 27 are for preventing the saw blade 10 from entering any farther into the grip 20.

The way of replacing a blade of the blade-replaceable saw of the present invention will now be described.

The saw blade 10, the grip 20, and the coupling means 30 are prepared as the members constituting the blade-replaceable saw.

Next, the insertion handle section 12 of the saw blade 10 is inserted into the insertion slot 22 of the grip 20. When the insertion handle section 12 reaches the deepest portion of the insertion slot 22, the through holes 23 of the grip 20 and the through holes 13 of the saw blade 10 are aligned. In this state, accurate fitting between the insertion handle section 12 of the saw blade 10 and the insertion slot 22 of the grip 20 is established.

An operator puts a bolt as the coupling means 30 into the through hole 23 of the grip 20 (the through hole 13 of the saw blade 10) and secures the bolt with a nut. Such joining of the saw blade 10 and the grip 20 by the coupling means 30 is performed at least at two through holes 23 on the respective sides, whereby the assembly of the blade-replaceable saw is completed.

On the other hand, when the saw blade 10 becomes dull by the use, for example, the saw blade 10 is replaced with a new one.

For replacement of the saw blade 10, first, the bolts and nuts as the coupling means 30 are removed.

The saw blade 10 is then held by hand at its saw blade body 11, and pulled out of the insertion slot 22 of the grip 20. At this time, conventionally, inside the insertion slot 22 of the grip 20, the insertion handle section 12 would likely be in close contact with the inner wall surfaces 22a, 22b of the insertion slot 22, and such a close contact state caused large pulling resistance, making it difficult to smoothly pull it out. With the configuration of the present invention, however, it has become possible to sufficiently alleviate the close contact state of the insertion handle section 12 of the saw blade 10 inside the insertion slot 22 of the grip 20, and accordingly, it has become possible to smoothly pull it out with reduced pulling resistance.

When the old saw blade 10 has been extracted, a newly prepared saw blade 10, specifically the insertion handle section 12 thereof, is inserted into the insertion slot 22 of the grip 20. In this case as well, the configuration of the present invention facilitates the insertion.

When the insertion handle section 22 has been inserted, the bolts and nuts as the coupling means 30 are used to join the saw blade 10 and the grip 20. In this manner, the replacement of the saw blade 10 is completed. In the blade-replaceable saw of the present invention, the gap between the saw blade 10 and the grip 20 inside the insertion slot 22 is restricted to be narrow, and therefore, looseness would hardly occur.

### INDUSTRIAL APPLICABILITY

The present invention has high industrial applicability as a blade-replaceable saw.

### DESCRIPTION OF THE REFERENCE CHARACTERS

10 saw blade
11 saw blade body
12 insertion handle section
13 through hole
20 grip
21 strap hole
22 insertion slot
22a inner wall surface
22b inner wall surface
23 through hole
24 rib-shaped projection
25 small projection
26 second projection
27 insertion preventing step
30 coupling means

1. A blade-replaceable saw having a saw blade and a grip, the saw blade having on a base side thereof a flat insertion handle section configured to be inserted into the grip, the grip having a flat insertion slot for receiving the insertion handle section of the saw blade, the saw enabling replacement of the saw blade, wherein
a projection is formed on an inner wall surface of the flat insertion slot of the grip, for reducing a contact area with, and also reducing a contact gap with, the flat insertion handle section of the saw blade.

2. The blade-replaceable saw according to claim 1, wherein the projection on the inner wall surface of the flat insertion slot of the grip is formed on each of the inner wall surfaces that face front and rear surfaces, respectively, of the flat insertion handle section of the saw blade.

3. The blade-replaceable saw according to claim 2, wherein the projections formed on the inner wall surfaces of the insertion slot of the grip to face the front and rear surfaces of the insertion handle section of the saw blade include elongated rib-shaped projections arranged along a longitudinal direction of the insertion slot.

4. The blade-replaceable saw according to claim 2, wherein the projections formed on the inner wall surfaces of the insertion slot of the grip to face the front and rear surfaces of the insertion handle section of the saw blade include a large number of small projections.

5. The blade-replaceable saw according to claim 3, wherein the projections formed on the inner wall surfaces of the insertion slot of the grip to face the front and rear surfaces of the insertion handle section of the saw blade include the rib-shaped projections and a large number of small projections.

6. The blade-replaceable saw according to claim 4, wherein instead of forming the small projections, surface roughening is carried out by one or more of electro-discharge machining, corrosion embossing, sandblasting, and other surface roughening processing.

7. The blade-replaceable saw according to claim 2, wherein the projections on the inner wall surfaces of the flat insertion slot of the grip also include projections formed on the inner wall surfaces that face surfaces in a thickness direction on respective sides in a shorter direction of the flat insertion handle section of the saw blade.

8. The blade-replaceable saw according to claim 1, wherein the saw blade is made of metal and the grip is made of rubber, resin, or other material having elasticity.

9. The blade-replaceable saw according to claim 5, wherein instead of forming the small projections, surface roughening is carried out by one or more of electro-discharge machining, corrosion embossing, sandblasting, and other surface roughening processing.

10. The blade-replaceable saw according to claim 3, wherein the projections on the inner wall surfaces of the flat insertion slot of the grip also include projections formed on the inner wall surfaces that face surfaces in a thickness direction on respective sides in a shorter direction of the flat insertion handle section of the saw blade.

11. The blade-replaceable saw according to claim 4, wherein the projections on the inner wall surfaces of the flat insertion slot of the grip also include projections formed on the inner wall surfaces that face surfaces in a thickness direction on respective sides in a shorter direction of the flat insertion handle section of the saw blade.

12. The blade-replaceable saw according to claim 5, wherein the projections on the inner wall surfaces of the flat insertion slot of the grip also include projections formed on the inner wall surfaces that face surfaces in a thickness direction on respective sides in a shorter direction of the flat insertion handle section of the saw blade.

13. The blade-replaceable saw according to claim 6, wherein the projections on the inner wall surfaces of the flat insertion slot of the grip also include projections formed on the inner wall surfaces that face surfaces in a thickness direction on respective sides in a shorter direction of the flat insertion handle section of the saw blade.

14. The blade-replaceable saw according to claim 2, wherein the saw blade is made of metal and the grip is made of rubber, resin, or other material having elasticity.

15. The blade-replaceable saw according to claim 3, wherein the saw blade is made of metal and the grip is made of rubber, resin, or other material having elasticity.

16. The blade-replaceable saw according to claim 4, wherein the saw blade is made of metal and the grip is made of rubber, resin, or other material having elasticity.

17. The blade-replaceable saw according to claim 5, wherein the saw blade is made of metal and the grip is made of rubber, resin, or other material having elasticity.

18. The blade-replaceable saw according to claim 6, wherein the saw blade is made of metal and the grip is made of rubber, resin, or other material having elasticity.

19. The blade-replaceable saw according to claim 7, wherein the saw blade is made of metal and the grip is made of rubber, resin, or other material having elasticity.
